(19) United States
(12) Patent Application Publication
(10) Pub. No.: US 2013/0236747 A1
(43) Pub. Date: Sep. 12, 2013

(54) Method system and apparatus for a dynamic battery

(71) Applicants: Yuda Gabai, Moshav Beet-Elaazari (IL); Izhak Dotan, Herzelya (IL); Galla Gabai, Moshav Beet-Elaazari (IL)

(72) Inventors: Yuda Gabai, Moshav Beet-Elaazari (IL); Izhak Dotan, Herzelya (IL); Galla Gabai, Moshav Beet-Elaazari (IL)

(21) Appl. No.: 13/417,340

(22) Filed: Mar. 12, 2012

(51) Int. Cl. H01M 6/02; H01M 10/02

(52) U.S. Cl. 429/50; 429/122

(57) ABSTRACT

The present invention innovates in method, system and apparatus of a dynamic battery producing electric energy, wherein, in the method, the present invention enables an electric battery made from battery sections that designated to enables a replacement of at list some of the battery components which are at their final discharge condition, to a new components that enabled the continual flows of the electrical energy, automatically, or by technologic mechanism, or by a manual action.

### BACKGROUND OF THE INVENTION

The current invention is at the field of electric energy produce from electrical batteries. More particularly, the invention relates to method, system and apparatus designated to produce to the user and to the electric operated devises and consumers, a higher production and output of an electric energy to enables a longer period of time operation of electrical devices by the batteries electrical power source, for improving electric vehicle operational abilities for example, or for improving electric devices and system operation abilities.

Electric energy produces by in electric batteries is one of the main energy sources which operating electric devices and system in the world. There are some archeological findings, even from ancient Egypt period of time, of basic electrical batteries made from ceramic jug, some acid liquids, and an Anode and Cathode putted inside the acid from one side and from their other side connected with conductive electricity wires, for example, to the electric device and electric consumer, for the purposes of electricity production and electric consumer operation.

These days, in this age, electric energy from electrical batteries enabled by, “solid batteries”, and by batteries type such of those used for example in motorized vehicles, which some of them includes liquid acid.

Conventional automobile batteries, for example, include a fairly standard sized rectangular casing inside, for example, of which are positioned cells (six for 12 volt batteries, three for 6 volt batteries for example). The cells each contain positive and negative battery plates and appropriate electrolytic fluid to allow the battery to produce, store, and recharge electrical power. The operation of a conventional battery is well known within the art and will not be explained further at this point. Normal automobile batteries are rated between approximately 300 amps cranking power for the weakest batteries up to 800 or 900 amps for the most powerful.

Conventional battery technology has improved considerably in the last decades. Conventionally sized automobile batteries have increased power, increased life, better response to discharge and recharge, and less maintenance than predecessors. This allows improved starting, as well prolonged operation of electrical equipment and auxiliary equipment with the automobile battery.

A significant problem still exists, however. If for any reason the conventional automobile battery loses power or is discharged, the needed source for electrical power is lost. There are no alternatives other than to jump start the automobile or to restore or replace the battery.

The examples of situations where this scenario occurs are legion. If automobile lights are left on for extended periods of time without the car running, discharge of the battery is inevitable. If other auxiliary equipment such as radios, fans, or the like are left on without the engine running, similar problems can occur. Electrical shorts or bad connections to the battery, so that it does not recharge during use, where failure of the battery leaves the vehicle basically helpless.

Other problems that come with reliance on a single battery are well known. Despite these problems, conventional batteries are almost universally utilized. Some attempts have been made to solve this problem but none have been accepted or apparently are satisfactory.

One example is the mounting of two or more conventional batteries in one automobile. When reserve power is needed, the second battery can be connected into the electrical system.

The problems with this system are very clear cut. The system doubles, or more than doubles the cost for battery power, utilizes twice the space, which many times precludes such a system being used, and requires additional needed hardware, such as connecting wiring, switches, and additional mounting structure.

The Baumheckel, Warren, Draper and Stroud patents utilize two separate batteries which are interconnected or switchable. Thiess describes a portable reserve battery canister which can be plugged into the automobile's electrical system through the cigarette lighter plug.

However, especially, the new approach of the increases in production and consuming an electrical vehicle at the last few years, see the electrical batteries development as the main task of that industries, and make the electrical batteries of those vehicles essential to that type of vehicle, and even to the hybrid type of vehicle, wherein, the main limitation of the electrical vehicle is because of the electrical battery limited power supply, which lives those vehicles in their most grave disadvantage compared to the vehicular types using fluid fuel, or the gas operated vehicles type for example. Wherein, the main disadvantage is due to the limited “route length” the electrical vehicle can provide until the batteries has to be recharge, or to be replaced, as the electrical battery is the main power of the electric vehicle. Wherein, solutions of multiple batteries, and even those of the “multiple solid batteries” to solve this problem are limited too, for the space it required, their high costs, and their increases weights upon the vehicle.

The present invention by its method, system and apparatus, have significant advantages over the existing prior arts, designated to enables an accommodating components in amount that is sufficient to at list partial, or at list one components replacement, or more, enabling to achieves extra production, and extra time of an electric power supplying, therefore, enabling an extra route length performances for electrical vehicle car for example, enabling for example for an electrical vehicle, to preforms 300 kilometer of constant driving, comparison to the existing batteries enabling 120 kilometer, wherein, this is the difference between a sufficient to a nun-sufficient performance from the vehicle driver point of view.

It is one of the objects of this invention to provide a method for electrical batteries and a method replacement of components in the electrical batteries which are needed to be recharged in order to a continual of production of an electric power producing.

It is another object of this invention to provide a system and mechanisms for electrical batteries, and for replacement of components in the electrical batteries which are needed to be recharged in order to a continual of production of an electric power production.

It is another object of this invention to provide an apparatuses and for electrical batteries, and for replacement of components in the electrical batteries, such as of “a nano-particles”, which are needed to be recharged in order to a continual of production of an electric power production.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention innovates in method, system and apparatus of a dynamic battery producing an electric energy, wherein, the method, enabling a producing of an electric current flow from an electrical battery for a longer operational period of time for an electrical consumer and devices, before needed to be recharged, wherein the method includes:

An electric battery comprising an accommodating panel with a matching materials fitted to enabling the electric current flow made when both the “anode” and the “cathode” are putted inside such a materials, and the battery connected to a closed electric circuit, wherein; Such “Anode” and the “Cathode” preformed in some implementations of the method an extension out of the matching materials that inside such accommodating panel, enabling an external connection of conductive connecting means, or wires between such “Anode” and the “Cathode” and electric devices and consumers preforming a closed electric circuit, wherein; Such “Anode” and the “Cathode” are made from materials that enables and maintain and carry out an electric current flow, when both are inside the panel matching materials, and when a conductive connecting means or wire connected to an electrical consumer and preforming a closed electric circuit, Wherein; Components such as the “Anode”, the “Cathode”, or both the “Anode” and the “Cathode”, has an extension of an additional materials of these components, located outside from the matching materials that inside the accommodating panel, wherein; Such components enabled to be replaced by appropriate and suitable apparatus, or system, or mechanism, to enable a continuant electric current flow. Wherein, optionally, in some of the implementations together with the matching materials in the panel, optionally can be the “Anode” or the “Cathode” component in a nun-replaced condition, and just the other one is the replaced component.

Wherein, in the method, the present invention enables an electric battery made from battery sections that designated to enables a replacement of at list some of the battery components which are at their final discharge condition, to a new components that enabled the continual flows of the electrical energy, automatically, or by technologic mechanism designated to enable the replacement of these components, or by a manual action and components replacement executed by the user.

Wherein, replacement of components of the dynamic battery is to be achieves by the method of the present invention by replacement of the components that causing, or that are at a final discharge abilities, that are not enabling electric flow, to a new components that are in a charged condition, that enabled the continual discharge abilities and flows of an electrical energy.

Wherein, the system of the present invention enables a technological mechanism fitted to enable the act of replacement of the sections and components in the battery which are at their final abilities to enables discharge condition and electric current flow, or that are responsible to that condition, and these, are to be replaced by the system mechanism to components that are at a charged condition that enabling the continual discharged and the electric current flow, these automatically, semi-automatically, or manually operation by the user, are to be by a new or charged components.

Wherein, the apparatus of the present invention enabling an apparatus such as a “cassette section” fitted to be connected to some of the dynamic battery section, and together to preforms a dynamic battery, or a dynamic battery and a technological mechanism, wherein, the “cassette section” includes components that are components in the battery which are at their final abilities to enables discharge condition and electric current flow, or that are responsible to that condition, and these, are to be replaced by the new “cassette section”, “old cassette section” are to be replaced by a “new cassette section”, wherein, the “new cassette section components” are at a charged condition that enabling the desirable continual discharged process that enables the continual electric current flow in the proper functioning battery, these automatic, semi-automatic, or manually operated by the user, as in the present invention.

Wherein, some implementation of the “cassette section” are a cassette section with a mechanical mechanism enabling the movement of components, such as of components that are in a form of a strip shape, for example, to pass the strip of the components forward, to replace at list some of the components that are responsible for the stoppage of the electrical current flow from the battery, for example, replacement, or combination of replacement of those: the “Anode”, the “Cathode”, or some of the acid fluid, for example in a vehicular dynamic type of batteries, for example, as in the present invention method, system and apparatus. Wherein, the replacement of the components of the “Anode”, and the “Cathode”, for example, which are cannot preform any more continuant electric current flow, because of the need to perform an electrical charge that will be enabled again these components to preformed electric current flow.

Wherein, such implementations enabled another implementation that charges parts of the strip that are in their final charged condition, enabling a longer life working period for the “cassette section” before changing it by a new one.

Wherein, such method, system and apparatus enabled in all batteries types, “Dry Batteries” and “liquid type Batteries”.

Wherein, such implementations enables another implementations that charged part of the strip for example, that is in its final charged condition, enabling at the dynamic batteries a strip components replacement, for example, moving part of the strip out of the liquid acid, for example in a vehicular batteries, and replacement of the “old part of the strip” by “a new part of the strip”, and optionally, recharging the “old component”, to enabled a longer life working period for the “cassette section” before changing it by a new one.

Wherein, such dynamic batteries types as in the present invention enabling another implementations of batteries, wherein, the battery includes at list the following components: a matching material such as liquid acid accommodated in the first battery section, a second section which accommodates components of the battery which at list some of them are to be replaced for the reasons it have to be electrical recharged to enables them a continual electrical current flows in the battery, wherein, such sections has a connecting means to enables the connection of them to the dynamic battery such as in the present invention.

Wherein, another implementations enabled by manually changing and replacing the second, section, including in it at list some of the charged required components, which can be a “cassette section”, wherein, the user can dismantle the dynamic battery from its existing “cassette section”, and replace it with “a new “cassette section”, enabling the continuant electrical current flow production by the batteries.

Wherein, another implementations enabled by technological mechanism, optionally motorized, enabling automatic, semi-automatic, or manual, replacing at list some of the recharge required components to achieve a continual electrical current flows, wherein, such components replaced by the technological mechanism, from a “cassette section” accommodating components, is in amount that is sufficient to at list partial, or at list one components replacement, or more, to achieves the desirable extra time end electric current flow, which enable, for example, an electrical vehicle, to preforms 300 kilometer of constant driving, compared to the existing batteries enabling approximately a 120 kilometer, wherein, this is the difference between the sufficient to the nun-sufficient performance of a vehicle, from the vehicle driver point of view.

Wherein, another type of implementation enabled in the method, the system and the apparatus the present invention, wherein such implementations further includes some “nano-particles” available in the present invention, these “nano particles” for examples are: “nano-particles” which some are located at some “cassette section” combined with system that enabling in one implementation of the present invention some “nano-particles” materials absorbed and saturated on some substrate in a form that enabling the system to transfer and use parts of the “nano-particles” to replace the used “nano particles” that cannot produce an electric current flow, by a new “nano-particles” from the “cassette section”, or from the accommodating section that some of the substrate containing the “nano particles” are located in, wherein, such apparatus can be optionally designated to enable the spread, or a continual spread and treatment of these“nano particles” on the substrate at the system surrounding, wherein, such spread can be performed for example by spraying or painting “nano particles” on the substrate at the system surrounding, and may have even a drying means to enable such applications, wherein, such substrate that the “nano particles” may be applied on, are for example substrate includes materials such as for a one time use, such as paper, fabric and other materials, or materials fitted to multiuse, wherein, the “nano particles” can be combined with the substrate by the batteries system and apparatus, or can be a replace part that is provided as one time use part, and include in it the substrate and the “nano particles”.

### BRIEF DESCRIPTION OF THE DRAWINGS

The added drawings in this patent request come in order to provide more visual understandings about the invention and are integral part of the request and the invention. The drawings describe different functions of the invention and, added to all the mentioned above, serve the purpose of explaining the principles and ways of operation and not, by any means, suppose to limit the invention solely to them.

FIG. 1 is a schematic description that shows an example of one implementation, included in the current invention, enabled in the method, the system and the apparatus of the present invention.

FIG. 2 is a schematic description that shows an example of another implementation, included in the current invention, enabled in the method, the system and the apparatus of the present invention.

FIG. 3 is a schematic description that shows an example of another implementation, included in the current invention, enabled in the method, the system and the apparatus of the present invention.

### DESCRIPTION OF THE PREFERRED EMBODIMENTS

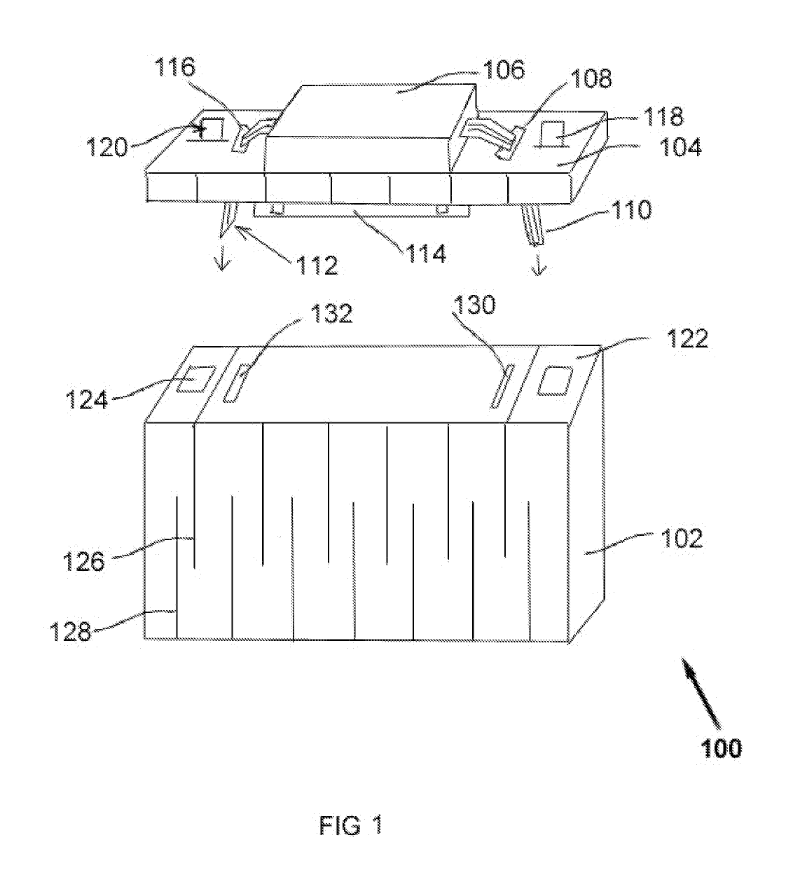

FIG. 1 is a schematic description that shows an example of one implementation 100, included in the current invention, enabled in the method, the system and the apparatus of the present invention.

Wherein, the method, enabling a producing of an electric current flow from an electrical battery 100 for a longer operational period of time for an electrical consumer and devices, before needed to be recharged, wherein, an electric battery comprising an accommodating panel 102 with a matching fluid materials such as acid, or the electrolytic fluid, or ions (An ion is an atom or molecule in which the total number of electrons is not equal to the total number of protons, giving it a net positive or negative electrical charge, allowing an electric current to pass between electrodes, when an electric field is applied) for example,

Wherein, such materials fitted to enables the electric current flow made when both the “anode” (positive electrode) and the “cathode” (negative electrode) are putted inside such a materials, and the battery 100 connected to a closed electric circuit, wherein the method describe enabling some optional conditions, (a) the “anode”, (b) or the “cathode”, (c) or both of the “anode” and the “cathode” are to be a replaceable components 128 and, Wherein, respectively, componnents 108, 110, 116, and 112, are the “anode”, or the “cathode”, or both of the “anode” and the “cathode”, are the replacement components, and optional have an extension to components 128 and 126, that are to be replaced by the extension componnents 108, 110, 116, and 112;

Wherein, in one optional perspective:
a. Such replaceable components of the “Anode” and the “Cathode”, 126 and 128, preformed an extension to components 110 and 112, out of the matching materials, that inside such accommodating panel 102, enabling an external connection of conductive connecting means, or wires between such “Anode” 118 and the “Cathode” 120 and electric devices and consumers preforming a closed electric circuit, wherein;
b. the “Anode” and the “Cathode” described in the options, are made from materials that enables and maintain and carry out an electric current flow, when both are inside the panel 102 matching materials, and when a conductive connecting means or wire connected to an electrical consumer and preforming a closed electric circuit, Wherein;
c. Components such as the “Anode”, the “Cathode”, or both the “Anode” and the “Cathode”, has an extension of an additional components 110, 112 of these materials, located outside from the matching material that inside the accommodating panel 102, wherein;
d. Such components 110, 112 enabled to be replaced by appropriate and suitable apparatus 104 which fitted to be connected to panel 102, and together by connecting means 114, and connection 122 conducts to 118, and 124 conducts to 120, preforms the dynamic battery, wherein, optional system, or mechanism 106, optionally with electric motor, pulling component 108 towards gap 130 into panel 102 matching materials, to enable a continuant electric current flow, and the “old components” from the inside panel 102, pulled out from gap 132 passes as component 112, 116 into compartment 106 which optionally further enables recharging the “old components” to enabled them to be fitted to continual replacement of the functioning components in panel 102, as in the method, system and the apparatus of the present invention.

Wherein, for a better understanding of more implementation enabled in the present method, system and apparatus, a few more explanations will be added:

Such extension of an additional materials 110, 112 of these components optionally separated by isolating area and materials, at the desirable spot fitted to the user purposes, to prevent flowing of the inner panel components reaction to the outer components.

wherein such additional components 110, 112 dedicated to implement as an extra components, are located at a suitable section fitted to be connected, and disconnected, a detachable section 104, from the battery other sections 102.
wherein such additional components 110, 112 dedicated to implement as an extra components, are located at a suitable section fitted to be connected, and disconnected, a detachable section 104, from the battery other sections 102, such section can preforms as a “cassette section” 104, wherein, implementation of such “cassette section” 104 can be designated to be fit to the present invention dynamic type of battery 100, and another implementations can be designated to be fitted to existing batteries. wherein such additional components dedicated to implement as an extra components 110, 112, such section can preforms as a “cassette section” 104, wherein, such “cassette section” 104 can be one which is fitted to manual replacement by the user, enabling to remove the existing “cassette section” connected to the dynamic type of battery, and replaced it by a new “cassette section”. Or, such “cassette section”104 can be one which have a mechanism, optionally an electric motorized mechanism 106, enabling an automatic, or semi-automatic replacement of the inner components in the battery, by a new components which enabling the continuant electric power supply by the battery.

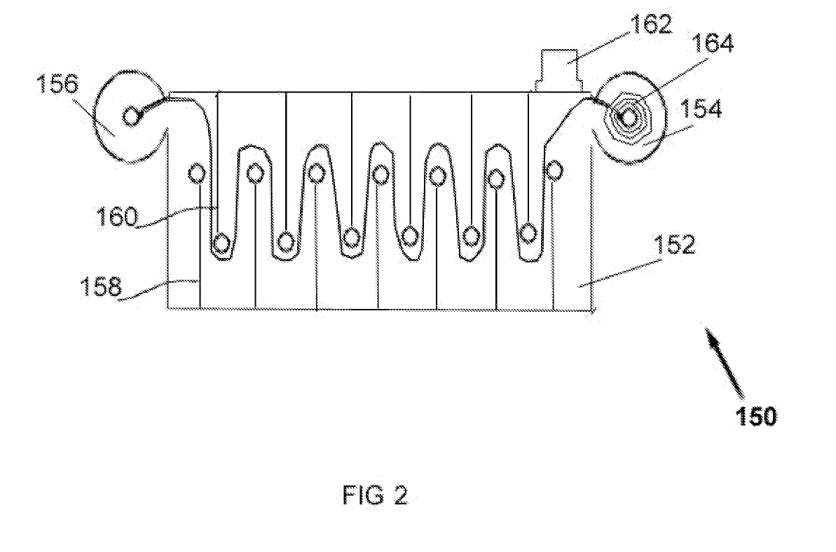

FIG. 2 is a schematic description that shows an example of another implementation 150, included in the current invention, enabled in the method, the system and the apparatus of the present invention, wherein, system designated for a dynamic batteries, enabling a producing of an electric current flow from an electrical battery for a longer operational period of time for an electrical consumer and devices, before needed to be recharged, wherein the system includes:
a. An electric battery comprising an accommodating panel 152 with a matching materials fitted to enables the electric current flow made when both the “anode” 158—a one optional implementation that the “anode” preforms as a static component, and its outer connection 162, and the “cathode” 164, with it replaceable components 154 that pulled towards section 156, are putted inside such a materials, and the battery connected to a closed electric circuit, wherein; for example, another option of implementation is that both the “Anode” and the “Cathode” are replaceable and moving components, no static component in the battery panel 152.
b. Such “Anode” and the “Cathode” preformed an extension out of the matching materials that inside such accommodating panel, enabling an external connection of conductive connecting means, or wires between such “Anode” and the “Cathode” and electric devices and consumers preforming a closed electrical circuit, wherein; Such “Anode” and the “Cathode” are made from materials that enables and maintain and carry out an electrical current flow, when both are inside the panel matching materials, and when a conductive connecting means or wire connected to an electrical consumer and preforming a closed electrical circuit, Wherein; Components such as the “Anode”, the “Cathode”, or both the “Anode” and the “Cathode”, optionally has an extension of an additional materials of these components, located outside from the matching materials that inside the accommodating panel, wherein; Such components enabled to be replaced automatically, semi-automatically, or manually, by the system, or by appropriate and suitable apparatus, to enable a continuant of the electric current flow.

Wherein such extension of an additional materials of these components are separated by isolating area and materials, at the desirable spot fitted to the user purposes, to prevent flowing of the inner panel components reaction to the outer components, wherein the system mechanism designated to replace the inner components with some of the outer components.
wherein such additional components enabled with the system dedicated to implement as an extra components, are located at a suitable section fitted to be connected, and disconnected, a detachable section, from the battery other sections.
wherein such additional components dedicated to implement as an extra components, are located at a suitable section fitted to be connected, and disconnected, a detachable section, from the battery other sections, such section can preforms as a “cassette section”, wherein, implementation of such “cassette section” can be designated to be fit to the present invention dynamic type of battery, and another implementations can be designated to be fitted to existing batteries, wherein, system and mechanism that enabling the replacement of the inner components with an external components, includes in the present invention in some of its implementations, in a automatic, and semi-automatic replacement for example exist a proper system and mechanism that enables the replacement, optionally by motorized electrical engine.
wherein such additional components dedicated to implement as an extra components, are located at a suitable section fitted to be connected, and disconnected, a detachable section, from the battery other sections, such section can preforms as a “cassette section”, wherein, such “cassette section” can be one which is fitted to a manual replacement by the user, a detachable “cassette section”, enabling by a detachable means, or by connecting means, to remove the to existing “cassette section” connected to the dynamic type of battery, and replaced it by a new “cassette section”.
wherein such additional components dedicated to implement as an extra components, are located at a suitable section fitted to be connected, and disconnected, a detachable section, from the battery other sections, such section can preforms as a “cassette section”, wherein, such “cassette section” can be one which have a system and mechanism, optionally an electric motorized mechanism, enabling an automatic, or semi-automatic replacement of the inner components in the battery, by a new components which enabling the continuant electric power supply by the battery.
wherein such section as a “cassette section”, further include, or connected to, a designed mechanism designated to recharge the old components that the system replaced, to enables them to preforms a continuant electric power supply by the battery in time that the system will put them again inside the battery.
wherein such section as a “cassette section”, further include, a battery meter that indicates the time which is optimum to replace the inner components of the battery to enable a continual electrical current flow from the battery, and to prevent stoppage in the power supply of electricity from the battery, wherein, such battery meter is optionally connected to computerized mechanism and to system that automatically, or semi-automatically send the commend to replaced components, and optionally to recharge the replaced components, to enables them to preforms a to continuant electric power supply by the battery.

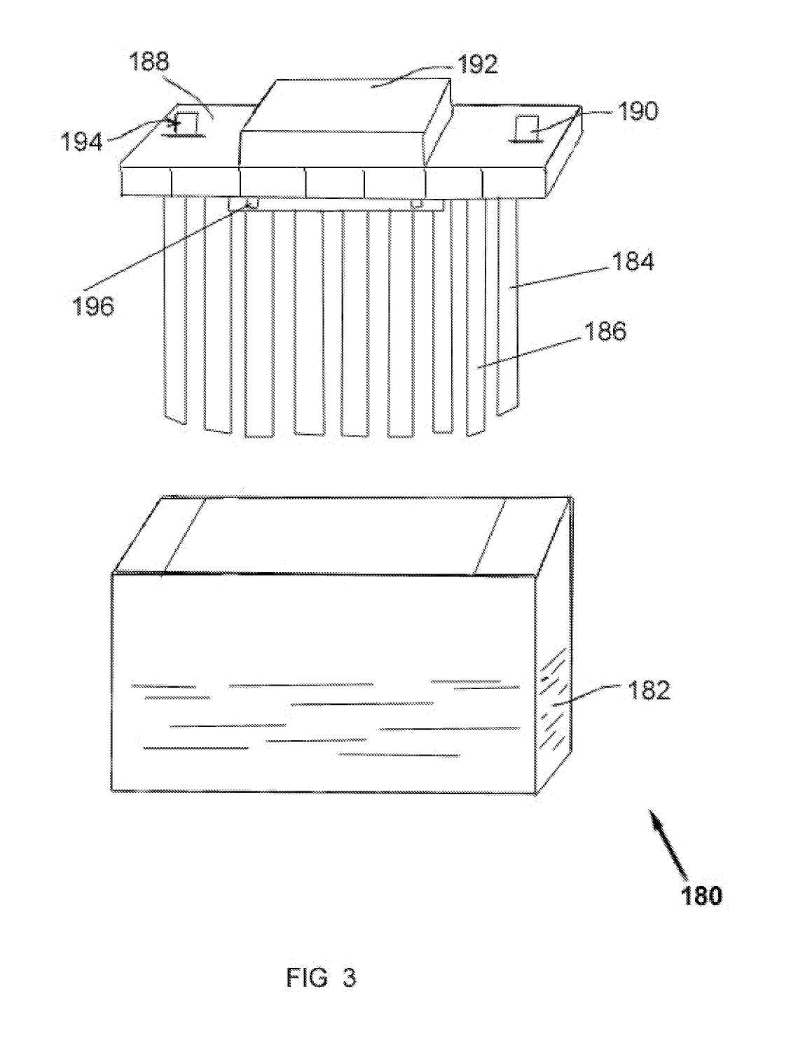

FIG. 3 is a schematic description that shows an example of another implementation 180, included in the current invention, enabled in the method, the system and the apparatus of the present invention, wherein, apparatus 180 include detachable section 188, fitted together with battery panel 182 to perform a dynamic batteries 180 which enabling a producing of an electric current flow from the electrical battery 180 for a longer operational period of time for an electrical consumer and devices, before needed to be recharged, wherein the apparatus fitted to such dynamic battery as follows:
a. An electric battery comprising an accommodating panel 182 with a matching materials fitted to enables the electric current flow made when both the “anode” 184 and the “cathode” 186 are putted inside such a materials, and the battery outer connection 190 and 194 connected to a closed electric circuit, wherein;

b. Such “Anode”184 and the “Cathode”186 are made from materials that enables and maintain and carry out an electrical current flow, when both are inside the panel matching materials 182, and when a conductive connecting means or wire connected to an electrical consumer and preforming a closed electrical circuit, Wherein;
c. Such apparatus 180 section 188, one type of many types of “cassette sections”, enabled to be replaced manually, by the user, to enable a continuant of the electric current, flow.
   wherein such “Anode” and the “Cathode” has no extension to external apparatus of the present invention, but the “Anode” and the “Cathode” are connected to the apparatus 180, or to part from its parts 188, or preforms as “a cassette section” 188, which is detachable by connecting means 196 from the dynamic battery others parts 182, designated to be replaced by the user to a new apparatus section 188, or part, or “cassette section”, wherein such a replacement designated to enable a continuant electric current flow from the battery.

Wherein, another type of implementation enabled in the method, the system and the apparatus the present invention, wherein such implementations further includes some “nano particles” available in the present invention, these “nano particles” for examples are: “nano particles” which some are located at some “cassette section” combined with system that enabling in one implementation of the present invention some “nano particles” materials absorbed and saturated on some substrate in a form that enabling the system to transfer and use parts of the “nano particles” to replace the used “nano particles” that cannot produce an electric current flow, by a new “nano particles” from the “cassette section”, or from the accommodating section that some of the substrate containing the “nano particles” are located in, wherein, such apparatus can be optionally designated to enable the spread, or a continual spread and treatment of these“nano particles” on the substrate at the system surrounding, wherein, such spread can be performed for example by spraying or painting “nano particles” on the substrate at the system surrounding, and may have even a drying means to enable such applications, wherein, such substrate that the “nano particles” may be applied on, are for example substrate includes materials such as for a one time use, such as paper, fabric and other materials, or materials fitted to multiuse, wherein, the “nano particles” can be combined with the substrate materials by the batteries system and apparatus, or can be a replaceable part or parts that are provided for one time use, and include in it the substrate and the “nano particles”. Wherein, in all implementations of the present invention, it is optional that some strip or some “nano particles” organized in a way that between of them located an isolated materials that insulated between one strip, or between some strips that forming the replaceable dynamic strip or strips of the batteries, or between some of the “nano particles”, for example, to insulated the materials that responsible for the negative and the positive reaction. Wherein, a recharging parts of the batteries component enabled in the batteries systems, or by taking out parts of the batteries to perform the charging outside of the batteries surroundings, or recharging is not perform, rather replacement of a one-time use cassette to a new cassette is preformed.

1. Method for enabling a producing of an electric current flow from an electrical battery for a longer operational period of time for an electrical consumer and devices, before needed to be recharged, wherein the method includes:
a. An electric battery comprising an accommodating panel with a matching materials fitted to enabling the electric current flow made when both the “anode” and the “cathode” are putted inside such a materials, and the battery connected to a closed electric circuit, wherein;
b. Such “Anode” and the “Cathode” preformed an extension out of the matching materials that inside such accommodating panel, enabling an external connection of conductive connecting means, or wires between such “Anode” and the “Cathode” and electric devices and consumers preforming a dosed electric circuit, wherein;
c. Such “Anode” and the “Cathode” are made from materials that enables and maintain and carry out an electric current flow, when both are inside the panel matching materials, and when a conductive connecting means or wire connected to an electrical consumer and preforming a closed electric circuit, Wherein;
d. Components such as the “Anode”, the “Cathode”, or both the “Anode” and the “Cathode”, has an extension of an additional materials of these components, located outside from the matching materials that inside the accommodating panel, wherein;
e. Such components enabled to be replaced by appropriate and suitable apparatus, or system, or mechanism, to enable a continuant electric current flow.

2. The method of claim 1, wherein such extension of an additional materials of these components are separated by isolating area and materials, at the desirable spot fitted to the user purposes, to prevent flowing of the inner panel components reaction to the outer components.

3. The method of claim 1, wherein such additional components dedicated to implement as an extra components, are located at a suitable section fitted to be connected, and disconnected, a detachable section, from the battery other sections.

4. The method of claim 1, wherein such additional components dedicated to implement as an extra components, are located at a suitable section fitted to be connected, and disconnected, a detachable section, from the battery other sections, such section can preforms as a “cassette section”, wherein, implementation of such “cassette section” can be designated to be fit to the present invention dynamic type of battery, and another implementations can be designated to be fitted to existing batteries.

5. The method of claim 1, wherein such additional components dedicated to implement as an extra components, are located at a suitable section fitted to be connected, and disconnected, a detachable section, from the battery other sections, such section can preforms as a “cassette section”, wherein, such “cassette section” can be one which is fitted to manual replacement by the user, enabling to remove the existing “cassette section” connected to the dynamic type of battery, and replaced it by a new “cassette section”.

6. The method of claim 1, wherein such additional components dedicated to implement as an extra components, are located at a suitable section fitted to be connected, and disconnected, a detachable section, from the battery other sections, such section can preforms as a “cassette section”, wherein, such “cassette section” can be one which have a mechanism, optionally an electric motorized mechanism, enabling an automatic, or semi-automatic replacement of the inner components in the battery, by a new components which enabling the continuant electric power supply by the battery.

7. The method of claim 6, wherein such section as a “cassette section”, further include, or connected to, a designed mechanism designated to recharge the replaced components, to enables them to preforms a continuant electric power supply by the battery.

8. The method of claim 6, wherein the method further include the abilities for enabling a producing of an electric current flow from the electrical batteries, wherein, such method further comprising:
a. Production of an electric batteries enabling an electric current flow, or electric batteries enabling a higher production and output of an electrical energy, or enabling a longer time of continual operation of an electrical devices, or enabling a smaller and light-weight batteries, for some electrical consumer and devices and systems, before needed to be recharged, wherein;
b. such production of an electric batteries made by some process exists in the “nanotechnology process”, wherein;
c. the “nanotechnology process” enable a production of “nano-particles” from different materials and components by different “nanotechnology process”, wherein,
d. such process enabling a “nano-particles” which have a good electrical conductivity and a high flow of electrons, wherein,
e. the production of the electrical batteries made by some of the process that transform some of the batteries components and materials to “nano-particles”, wherein,
f. some of the batteries components and materials that enabled to be transformed to “nano-particles” are: the batteries components and materials that by changing them to “nano-particles”, the flow of electrons between the batteries components and materials is increase compared to the flow of the electrons before changing them; or some of the “cassette section” components and parts; or these components and materials that the conductivity will changed to a better conductivity; or these components and materials that the Absorption or the release of electrons between the batteries components and materials will increases, wherein,
g. some of the batteries components and materials that can be transformed to “nano-particles” by the method and the electric batteries of the present invention are: the acid; the Ionic liquid; the components and materials that embodies the Anode, the positive pole; the Cathode, the negative pole; components and materials that influencing and enabling the flow of electrons between the batteries components and materials; some of the “cassette section” components and parts.

9. Method as in claim 8, wherein some of the “nanotechnology process” available in the present method for examples are: by “top-down” method, in this method a force is activated upon some material for crush the material particles to a nanometers size, wherein, another “nanotechnology process” that enable a production of nano-particles from different materials is by “bottom-up” method for example, in this method a wet chemical synthesis activated upon some compounds, in some conditions (temperature, pressure, time period and more . . . ), and by the chemical reaction and the relevant conditions, the compounds particles size changed to a nanometers size.

10. system designated for a dynamic batteries, enabling a producing of an electric current flow from an electrical battery for a longer operational period of time for an electrical consumer and devices, before needed to be recharged, wherein the system includes:
a. An electric battery comprising an accommodating panel with a matching materials fitted to enables the electric current flow made when both the “anode” and the “cathode” are putted inside such a materials, and the battery connected to a closed electric circuit, wherein;
b. Such “Anode” and the “Cathode” preformed an extension out of the matching materials that inside such accommodating panel, enabling an external connection of conductive connecting means, or wires between such “Anode” and the “Cathode” and electric devices and consumers preforming a dosed electrical circuit, wherein;
c. Such “Anode” and the “Cathode” are made from materials that enables and maintain and carry out an electrical current flow, when both are inside the panel matching materials, and when a conductive connecting means or wire connected to an electrical consumer and preforming a closed electrical circuit, Wherein;
d. Components such as the “Anode”, the “Cathode”, or both the “Anode” and the “Cathode”, optionally has an extension of an additional materials of these components, located outside from the matching materials that inside the accommodating panel, wherein;
e. Such components enabled to be replaced automatically, semi-automatically, or manually, by the system, or by appropriate and suitable apparatus, to enable a continuant of the electric current flow.

11. The system of claim 10, wherein such extension of an additional materials of these components are separated by isolating area and materials, at the desirable spot fitted to the user purposes, to prevent flowing of the inner panel components reaction to the outer components, wherein the system mechanism designated to replace the inner components with some of the outer components.

12. The system of claim 10, wherein such additional components enabled with the system dedicated to implement as an extra components, are located at a suitable section fitted to be connected, and disconnected, a detachable section, from the battery other sections.

13. The system of claim 10, wherein such additional components dedicated to implement as an extra components, are located at a suitable section fitted to be connected, and disconnected, a detachable section, from the battery other sections, such section can preforms as a “cassette section”, wherein, implementation of such “cassette section” can be designated to be fit to the present invention dynamic type of battery, and another implementations can be designated to be fitted to existing batteries, wherein, system and mechanism that enabling the replacement of the inner components with an external components, includes in the present invention in some of its implementations, in a automatic, and semi-automatic replacement for example exist a proper system and mechanism that enables the replacement, optionally by motorized electrical engine.

14. The system of claim 10, wherein such additional components dedicated to implement as an extra components, are located at a suitable section fitted to be connected, and disconnected, a detachable section, from the battery other sections, such section can preforms as a “cassette section”, wherein, such “cassette section” can be one which is fitted to a manual replacement by the user, a detachable “cassette section”, enabling by a detachable means, or by connecting means, to remove the existing “cassette section” connected to the dynamic type of battery, and replaced it by a new “cassette section”.

15. The system of claim 10, wherein such additional components dedicated to implement as an extra components, are located at a suitable section fitted to be connected, and disconnected, a detachable section, from the battery other sections, such section can performs as a “cassette section”, wherein, such “cassette section” can be one which have a system and mechanism, optionally an electric motorized mechanism, enabling an automatic, or semi-automatic replacement of the inner components in the battery, by a new components which enabling the continuant electric power supply by the battery.

16. The system of claim 15, wherein such section as a “cassette section”, further include, or connected to, a designed mechanism designated to recharge the old components that the system replaced, to enables them to preforms a continuant electric power supply by the battery in time that the system will put them again inside the battery.

17. The system of claim 15, wherein such section as a “cassette section”, further include, a battery meter that indicates the time which is optimum to replace the inner components of the battery to enable a continual electrical current flow from the battery, and to prevent stoppage in the power supply of electricity from the battery, wherein, such battery meter is optionally connected to computerized mechanism and to system that automatically, or semi-automatically send the commend to replaced components, and optionally to recharge the replaced components, to enables them to preforms a continuant electric power supply by the battery.

18. The system of claim 15, wherein the system further include the abilities for enabling a producing of an electric current flow from the electrical batteries, wherein, such system further comprising:
a. A system enabling a production of an electric batteries enabling an electric current flow, or electric batteries enabling a higher production and output of an electrical energy, or enabling a longer time of continual operation of an electrical devices, or enabling a smaller and light-weight batteries, for some electrical consumer and devices and systems, before needed to be recharged, wherein;
b. such production of an electric batteries made by some process exists in the “nanotechnology process”, wherein;
c. the “nanotechnology process” enable a production of “nano-particles” from different materials and components by different “nanotechnology process”, wherein,
d. such process enabling a “nano-particles” which have a good electrical conductivity and a high flow of electrons, wherein,
e. the production of the electrical batteries made by some of the process that transform some of the batteries components and materials to “nano-particles”, wherein,
f. some of the batteries system and components and materials that includes “nano-particles” are: the batteries components and materials that by changing them to “nano-particles”, the flow of electrons between the batteries components and materials is increase compared to the flow of the electrons before changing them; or some of the “cassette section” components and parts; or these components and materials that the conductivity will changed to a better conductivity; or these components and materials that the Absorption or the release of electrons between the batteries components and materials will increases, wherein,
g. some of the batteries systems and components and materials that can be transformed to “nano-particles” by the method and the electric batteries of the present invention are: the acid; the Ionic liquid; the components and materials that embodies the Anode, the positive pole; the Cathode, the negative pole; components and materials that influencing and enabling the flow of electrons between the batteries components and materials; some of the “cassette section” components and parts.

19. system as in claim 18, wherein some of the “nano particles” available in the present system for examples are: “nano particles” which some are located at some “cassette section” combined with system that enabling in one implementation of the present invention some “nano particles” materials absorbed and saturated on some substrate in a form enabling the system to transfer and use parts of the “nano particles” to replace the used “nano particles” that cannot produce an electric current flow, by a new “nano particles” from the “cassette section”, or from the accommodating section that some of the substrate containing the “nano particles” are located in, wherein, such system can be optionally designated to enable the spread, or a continual spread and treatment of the“nano particles” on the substrate at the system surrounding wherein, a recharging parts of the batteries component enabled in the batteries systems, or by taking out parts of the batteries to perform the charging outside of the batteries surroundings, or recharging is not perform, rather replacement of a one-time use cassette to a new cassette is preformed.

20. Apparatus fitted for a dynamic batteries which enabling a producing of an electric current flow from the electrical battery for a longer operational period of time for an electrical consumer and devices, before needed to be recharged, wherein the apparatus fitted to such dynamic battery as follows:
a. An electric battery comprising an accommodating panel with a matching materials fitted to enables the electric current flow made when both the “anode” and the “cathode” are putted inside such a materials, and the battery connected to a closed electric circuit, wherein;
b. Such “Anode” and the “Cathode” preformed an extension out of the matching materials that inside such accommodating panel, enabling an external connection of conductive connecting means, or wires between such “Anode” and the “Cathode” and electric devices and consumers preforming a dosed electrical circuit, wherein;
c. Such “Anode” and the “Cathode” are made from materials that enables and maintain and carry out an electrical current flow, when both are inside the panel matching materials, and when a conductive connecting means or wire connected to an electrical consumer and preforming a closed electrical circuit, Wherein;
d. Components such as the “Anode”, the “Cathode”, or both the “Anode” and the “Cathode”, optionally has an extension of an additional materials of these components, located outside from the matching materials that inside the accommodating panel, wherein;
e. Such components enabled to be replaced automatically, semi-automatically, or manually, by a system, or by appropriate and suitable apparatus, to enable a continuant of the electric current flow.

21. The apparatus of claim 20, wherein such extension of an additional materials of these components are separated by isolating area and materials, at the desirable spot fitted to the user purposes, to prevent flowing of the inner panel components reaction to the outer components, wherein the apparatus mechanism designated to replace the inner components with some of the outer components.

22. The apparatus of claim 20, wherein such additional components enabled with the mechanism dedicated to implement as an extra components, are located at a suitable section fitted to be connected, and disconnected, a detachable section, from the battery other sections.

23. The apparatus of claim 20, wherein such additional components dedicated to implement as an extra components, are located at a suitable section fitted to be connected, and disconnected, a detachable section, from the battery other sections, such section can preforms as a “cassette section”, wherein, implementation of such “cassette section” can be designated to be fit to the present invention dynamic type of battery, and another implementations can be designated to be fitted to existing batteries, wherein, the apparatus and mechanism enabling the replacement of the inner components with an external components, includes in the present invention in some of its implementations, in a automatic, and semi-automatic replacement for example exist a proper system and mechanism that enables the replacement, optionally by motorized electrical engine.

24. The apparatus of claim 20, wherein such “Anode” and the “Cathode” has no extension to external apparatus of the present invention, but the “Anode” and the “Cathode” are connected to the apparatus, or part from its parts, or preforms as “a cassette section”, which is detachable from the dynamic battery others pars, designated to be replaced by the user to a new apparatus, or part, or “cassette section”, wherein such a replacement designated to enable a continuant electric current flow from the battery.

25. The apparatus of claim 20, wherein such apparatus further includes some “nano particles” available in the present invention, these “nano particles” for examples are: “nano particles” which some are located at some “cassette section” combined with system that enabling in one implementation of the present invention some “nano particles” materials absorbed and saturated on some substrate in a form that enabling the system to transfer and use parts of the “nano particles” to replace the used “nano particles” that cannot produce an electric current flow, by a new “nano particles” from the “cassette section”, or from the accommodating section that some of the substrate containing the “nano particles” are located in, wherein, such apparatus can be optionally designated to enable the spread, or a continual spread and treatment of these“nano particles” on the substrate at the system surrounding.
